(19) United States
(12) Patent Application Publication
(10) Pub. No.: US 2025/0196242 A1
(43) Pub. Date: Jun. 19, 2025

(54) DEVICE FOR CHAMFER MACHINING

(71) Applicant: Liebherr-Verzahntechnik GmbH, Kempten (DE)

(72) Inventors: Philipp STÖLZLE, Memmingen (DE); Gebhard HAAS, Altusried (DE)

(21) Appl. No.: 18/977,811

(22) Filed: Dec. 11, 2024

(30) Foreign Application Priority Data
Dec. 15, 2023 (DE) 10 2023 135 391.8

(51) Int. Cl. B23F 19/10; B23F 23/00; B23F 23/12

(52) U.S. Cl. CPC B23F 19/105; B23F 23/006; B23F 23/1218

(57) ABSTRACT

Device for chamfer machining of a toothed workpiece, wherein the device comprises at least one workpiece spindle having a rotatably mounted workpiece holder for holding the workpiece, and a machining head that is movable relative to the workpiece spindle via at least one linear axis, wherein at least one tool spindle having a rotatably mounted tool holder for holding at least one tool for machining a workpiece held in the workpiece holder is provided on the machining head, and wherein a milling spindle having a rotatably mounted milling cutter holder for holding an end milling cutter for chamfer machining an edge of a toothing of the workpiece held in the workpiece holder is provided on the machining head, wherein the work angle of an end milling cutter held in the milling cutter holder relative to the edge of the toothing can be set via a first pivot axis.

### CROSS REFERENCE TO RELATED APPLICATION

The present application claims priority to German Patent Application No. 10 2023 135 391.8 filed on Dec. 15, 2023. The entire contents of the above-listed application are hereby incorporated by reference for all purposes.

### TECHNICAL FIELD

The present disclosure relates to a device for chamfer machining of a toothed workpiece.

### BACKGROUND

A device of this kind is used to provide the edges of a toothed workpiece with a chamfer. This prevents the sharp edges of the toothing from being an injury risk in the context of further handling of the workpieces or leading to damage to other workpieces or tools.

### SUMMARY

A chamfering device is known for example from patent document DE 10 2018 108 632 A1. In this case, a milling spindle for holding an end milling cutter on a machining head is provided, which spindle can be moved via a plurality of linear axes. In this case, the work angle of the end milling cutter can be set via a pivot axis, by means of which the milling spindle is arranged on the machining head.

A similar configuration is also disclosed in patent document DE 10 2018 108 622 A1. In this case, the milling spindle is arranged on a machining head which comprises a further tool holder in which a further chamfering tool is held. Depending on the accessibility of the corresponding edges of the workpiece, in this case either the end milling cutter or the other chamfering tool can be used.

Patent document DE 10 2014 014 132 A1 discloses a configuration in which a milling spindle is arranged by means of a pivot arm on a machining head, on which in turn a tool holder for holding a grinding or milling tool, with which the toothing itself is produced, is arranged. In this case, the chamfering milling cutter arranged in the milling spindle is arranged, by means of the pivot arm, perpendicularly to an upper or lower end edge of the toothing of the workpiece and produces a milling angle which is specified by the shape of the chamfering milling cutter. A pivot axis arranged on the pivot arm serves to set the chamfering milling cutter selectively from above onto the upper edge or from below onto the lower edge of the workpiece.

The object of the present disclosure is that of providing an improved chamfering device.

This object is achieved by means of a chamfering device as described herein.

The present disclosure comprises a device for chamfer machining of a toothed workpiece, wherein the device comprises at least one workpiece spindle having a rotatably mounted workpiece holder for holding the workpiece, and a machining head that is movable relative to the workpiece spindle via at least one linear axis, wherein at least one tool spindle having a rotatably mounted tool holder for holding at least one tool for machining a workpiece held in the workpiece holder is provided on the machining head, and wherein a milling spindle having a rotatably mounted milling cutter holder for holding an end milling cutter for chamfer machining an edge of a toothing of the workpiece held in the workpiece holder is provided on the machining head, wherein the work angle of an end milling cutter held in the milling cutter holder relative to the edge of the toothing can be set via a first pivot axis. According to the disclosure it is provided that the milling spindle is pivotably arranged on a pivot arm via the first pivot axis, wherein the pivot arm in turn is pivotably arranged on the machining head via a second pivot axis which is oriented in parallel with the first pivot axis.

The inventors of the present disclosure have found that the arrangement of the milling spindle on a pivot arm and the two parallel pivot axes provided for pivoting the pivot arm and the milling spindle allow for more accurate and quicker production of chamfers than according to the prior art, wherein the arrangement on the machining head allows for chamfering sequentially to a preceding or following machining step, without the workpiece or tool having to be re-chucked or changed.

According to a possible embodiment of the present disclosure, the axis of rotation of the milling spindle is positioned perpendicularly on the second pivot axis.

According to a possible embodiment of the present disclosure, the axis of rotation of the milling spindle can be pivoted via the second pivot axis in a plane which extends in parallel with the axis of rotation of the workpiece spindle.

According to a possible embodiment of the present disclosure, the first and the second pivot axis extend in parallel with the axis of rotation of the tool spindle.

According to a possible embodiment of the present disclosure, the device comprises a first drive for the first pivot axis and a second drive for the second pivot axis, and a controller for actuating the first and the second drive. The chamfering process can be automated as a result. In particular, the first and/or the second drive can be an NC drive.

According to a possible embodiment of the present disclosure, the controller is configured and/or programmed to actuate the first drive in a machining position for setting the work angle of an end milling cutter held in the milling cutter holder relative to the edge of the toothing, and/or for switching between machining of an upper edge and a lower edge of the toothing.

According to a further possible embodiment of the present disclosure, the controller is configured and/or programmed to position the milling spindle in such a way in a machining position in which an end milling cutter held in the milling cutter holder extends proceeding from a position beside the workpiece with an oblique orientation to the edge of the toothing. In particular, in this case the milling cutter can extend upwards from laterally below to an upper edge, or can extend downwards from laterally above to a lower edge.

According to a further possible embodiment of the present disclosure, the controller is configured and/or programmed to move the pivot arm with the milling spindle from a machining position into a parked position and/or back.

The controller may be configured and/or programmed in such a way that the first and the second pivot axis are moved into the machining position upon movement, such that an angle between the axis of rotation of the milling spindle and a main extension direction of the pivot arm changes.

In particular, in this case the first pivot axis can be moved so as to thread the end milling cutter into a tooth gap, and/or so as to set the desired work angle relative to the edge, and thus the chamfer angle created. In contrast, the second pivot axis is moved so as to move the milling spindle from the parked position into a machining position in front of the workpiece, in which position the milling spindle is arranged in front of a tool held in the tool holder of the machining head.

According to a further possible embodiment of the present disclosure, the device comprises a controller for actuating an NC drive of the second pivot axis and optionally for actuating an NC drive of the first pivot axis, an NC drive of the at least one linear axis of the machining head, and/or an NC drive of the workpiece spindle.

According to a possible embodiment of the present disclosure, the controller comprises a chamfer machining function which is configured and/or programmed to actuate the second pivot axis, during chamfer machining, synchronously to a rotation of the workpiece spindle, in order to guide an end milling cutter, held in the milling cutter holder, in a controlled manner along the edge of a toothed workpiece held in the workpiece holder and in particular through the individual tooth gaps. In this case, the second pivot axis has a function comparable to a linear axis extending in parallel with the axis of rotation of the workpiece, in that it guides the milling spindle and thus the end milling cutter in a direction in parallel with the axis of rotation of the workpiece, following the contour of the individual tooth gaps of the toothing, along the edge of the toothing. Compared with a movement of the machining head, the use of the second pivot axis has the advantage that a very much lower mass has to be moved, such that the chamfer machining can take place more quickly and more precisely.

According to a possible embodiment of the present disclosure, the chamfer machining function is furthermore configured and/programmed to also actuate the first pivot axis synchronously to a rotation of the workpiece spindle during chamfer machining. On the one hand, as a result changes in the work angle, which result due to the movement of the pivot arm by the second pivot axis, can be compensated. On the other hand, a work angle of the end milling cutter that changes in a targeted manner over a tooth gap can be achieved. As a result, for example the size and/or the chamfer angle of the chamfer can be purposely influenced, in a plane which extends in parallel with the axis of rotation of the workpiece and is located perpendicularly on the flank of the toothing and can optionally be configured to be more homogeneous over the tooth gap.

According to a possible embodiment of the present disclosure, the at least one linear axis, via which the machining head is movable, is actuated for setting the initial position of the milling spindle relative to the workpiece.

In particular in this case a linear axis which is positioned perpendicularly on the axis of rotation of the workpiece spindle and/or the axis of rotation of the tool spindle and/or serves for setting an axial spacing between the axis of rotation of the workpiece spindle and the axis of rotation of the tool spindle, and/or a linear axis which extends in parallel with the axis of rotation of the workpiece spindle, is actuated for setting the initial position of the milling spindle relative to the workpiece.

According to a possible embodiment of the present disclosure, the machining head is movable via at least one linear axis in parallel with the axis of rotation of the tool holder and/or in parallel with the first and/or second pivot axis, wherein the controller is configured and/or programmed to actuate the linear axis for setting the initial position of the milling spindle relative to the workpiece. In particular, in this case the controller is configured and programmed to actuate the linear axis in such a way that the end milling cutter is arranged, for chamfer machining, eccentrically relative to the workpiece, and/or the axis of rotation of the end milling cutter extends in a plane which does not intersect with the axis of rotation of the workpiece spindle but rather is arranged in parallel with and spaced apart from a radial plane in which the axis of rotation of the workpiece spindle extends. This provides advantages in the chamfer machining in particular in the case of helical teeth.

According to a possible embodiment of the present disclosure, the linear axes are actuated only for setting the initial position of the milling spindle relative to the workpiece and are not moved during the chamfer machining.

In an alternative embodiment, however, at least one or more linear axes, via which the machining head is movable, can also be moved during the chamfer machining, synchronously with the rotational movement of the workpiece and in particular through the individual tooth gaps.

According to a possible embodiment of the present disclosure, the machining head is movable via at least one linear axis in parallel with the axis of rotation of the tool holder and/or in parallel with the first and/or second pivot axis, wherein the chamfer machining function is configured and/or programmed to actuate the linear axis synchronously with a rotation of the workpiece spindle.

As a result, the position of the end milling cutter relative to a central plane of the workpiece can be varied via the tooth gap. This results in advantages, in particular in the case of chamfer machining of helical teeth, with respect to the influencing of the chamfer contour and in particular a more uniform chamfer over the tooth gap.

According to a possible embodiment of the present disclosure, a threading sensor is arranged on the pivot arm.

The controller may be configured and/or programmed to detect the position of the teeth or tooth gaps of the toothing in the peripheral direction of the workpiece, and/or the position of at least one edge of the toothing in the axial direction of the workpiece, before the chamfer machining, by means of the threading sensor, in order to thread the end milling cutter for the chamfer machining into the tooth gaps of the toothing or to synchronize the movement of the end milling cutter with the rotational movement of the workpiece in such a way that the end milling cutter is guided along the edge of the toothing in order to chamfer the edge.

The controller may be configured and/or programmed to detect the position of at least one edge of the toothing in the axial direction of the workpiece, before the chamfer machining, by means of the threading sensor, in order to position the end milling cutter, in the axial direction, in the correct position relative to the edge in order to create the desired size of the chamfer. This option may be important when a very precise chamfer size is important and the workpiece tolerances allow too much leeway, such that the axial position of the edge is not known in advance with a sufficient degree of accuracy.

A substantial advantage of this embodiment compared with an arrangement of the threading sensor on the main part of the machining head is the increased speed, since the threading sensor is arranged close to the chamfer machining position due to the arrangement on the pivot arm, on which the milling spindle for the end milling cutter is arranged. Therefore, after identifying the tooth gap, all that is then required is for the milling spindle to be pivoted into the gap, without the threading sensor having to be moved.

In contrast, a threading sensor arranged on the machining head itself would first have to be moved into a position in front of the toothing, in order to detect the tooth gap, and subsequently be moved back into its parked position. Only thereafter could the milling head with the end milling cutter then be delivered to the workpiece.

The arrangement of a threading sensor on the pivot arm is also subject matter of the present disclosure, independently of the embodiment described hitherto.

The present disclosure therefore comprises, in a second independent aspect, a device for chamfer machining of a toothed workpiece, wherein the device comprises at least one workpiece spindle having a rotatably mounted workpiece holder for holding the workpiece, and a machining head that is movable relative to the workpiece spindle via at least one linear axis, wherein at least one tool spindle having a rotatably mounted tool holder for holding at least one tool for machining a workpiece held in the workpiece holder is provided on the machining head, and wherein a milling spindle having a rotatably mounted milling cutter holder for holding an end milling cutter for chamfer machining an edge of a toothing of the workpiece held in the workpiece holder is provided on the machining head, wherein the milling spindle is arranged on the machining head via a pivot arm. The second aspect is characterized in that a threading sensor is arranged on the pivot arm.

This results in the advantages already described above.

Embodiments, which have already been described above with respect to the first aspect of the present disclosure, are also implemented in the case of the device according to the second aspect.

Furthermore, as already described, the second aspect may be combined with the first aspect.

Further embodiments which can be used both with the second aspect and with the first aspect, or the combination thereof, will be described in more detail in the following.

According to a possible embodiment of the present disclosure, the threading sensor is arranged on the free end of the pivot arm, in particular on a mounting region for a second pivot axis by means of which the milling spindle is arranged on the pivot arm.

According to a possible embodiment of the present disclosure, the pivot arm is pivotably arranged on the machining head via a first pivot axis and the device comprises a controller which is configured and/or programmed to move the pivot arm into a measuring position in which the threading sensor is located in front of the toothing to be measured.

According to a possible embodiment of the present disclosure, the milling spindle is arranged on the pivot arm via a second pivot axis and the controller actuates the second pivot axis in such a way that an end milling cutter held in the milling spindle is located out of engagement with the toothing in the measuring position.

According to a possible embodiment of the present disclosure, the controller is configured and/or programmed to bring the end milling cutter into engagement with the edge by pivoting the milling spindle via the second pivot axis, after the tooth gaps of the toothing have been detected by the threading sensor. As a result, the end milling cutter can dip into the tooth gap in a controlled manner without moving the threading sensor, and perform the chamfer machining following the tooth contour.

According to a possible embodiment of the present disclosure, the threading sensor is a sensor that operates in a contactless manner, in particular an inductive, capacitive and/or optical sensor. Such a sensor that operates in a contactless manner has to detect only two tooth tips in order to calculate therefrom the center of the tooth gap.

According to a possible embodiment of the present disclosure, a work region for the tool on the machining head is limited to the rear by a boundary wall provided behind the tool, wherein the second pivot axis is arranged on the machining head in a region in front of the boundary wall. As a result, the pivot arm is arranged in the vicinity of the tool spindle and the milling spindle can easily reach the workpiece by pivoting of the pivot arm.

According to a possible embodiment of the present disclosure, the pivot arm extends upwards, in a parked position, along the boundary wall, and optionally ends below an upper edge of the boundary wall. As a result, the pivot arm does not form an interfering contour for the machining with the tool held in the tool spindle.

According to a possible embodiment of the present disclosure, the pivot arm is arranged axially beside the tool holder with respect to the direction of the axis of rotation of the tool spindle and therefore pivots in a region beside a tool held in the tool holder. In particular, the pivot arm is arranged beside the tool holder with respect to the direction of the axis of rotation of the tool spindle, axially in the direction of a main bearing of the workpiece spindle.

According to a possible embodiment of the present disclosure, the second pivot axis is arranged on a housing of the main bearing of the tool spindle.

According to a possible embodiment of the present disclosure, an element that extends in the axial direction with respect to the axis of rotation of the workpiece spindle, on which element the milling spindle is arranged, is arranged on the free end of the pivot arm. As a result, the milling spindle can be arranged in a region in front of a tool held in the tool holder of the tool spindle. As a result, in the case of a change between machining of the tool and a chamfer machining by the end milling cutter, the travel path for the machining head is reduced.

The first pivot axis can be arranged between the pivot arm and the element extending in the axial direction, or between the element extending in the axial direction and the milling spindle.

According to a possible embodiment of the present disclosure, the device comprises a sensor for breakage control of an end milling cutter held in the milling cutter holder, wherein the sensor is optionally arranged such that it checks the end milling cutter in a parked position of the pivot arm. In particular, in this case, the sensor can be arranged at an upper edge of a boundary wall, as has been described above.

According to a possible embodiment of the present disclosure, the tool spindle is a tool spindle for toothed machining of a workpiece held in the workpiece holder, i.e. for performing machining by which the toothing itself is produced and/or machined. In particular, the toothed machining can be tooth milling.

According to a possible embodiment of the present disclosure, the device is therefore a toothing machine, in particular a tooth milling machine, which is equipped with a function for chamfer milling.

According to a possible embodiment of the present disclosure, the machining head is movable via at least two and optionally three linear axes.

According to a possible embodiment of the present disclosure, a first linear axis is provided for movement in a direction perpendicular to the axis of rotation of the workpiece holder and perpendicular to the axis of rotation of the tool holder, and/or a second linear axis is provided for movement in a direction in parallel with the axis of rotation of the workpiece holder.

According to a possible embodiment of the present disclosure, the machining head is pivotable via a pivot axis, relative to the workpiece spindle, in particular for setting an axis intersection angle, wherein the pivot axis optionally extends perpendicularly to the axis of rotation of the workpiece holder and perpendicularly to the axis of rotation of the tool holder.

The controller according to the disclosure can comprise a microcontroller and a non-volatile memory in which a computer program is stored which is executed on the microcontroller. In this case, the controller is in signal connection with the drives and actuates these. In particular, the computer program is configured in this case in such a way that, if it is executed on the microcontroller, it implements the functions of the controller described above and in the following, or actuates the device according to the disclosure, in such a way that said device performs the method described above and in the following.

According to a possible embodiment of the present disclosure, the controller is configured and/or programmed in such a way that it automatically performs the method described above and in the following, and/or performs it identically in each case for a plurality of identical workpieces.

According to a possible embodiment of the present disclosure, the workpiece which can undergo chamfer machining by means of the device according to the disclosure is a gearwheel, in particular a gearwheel having spur toothing. In particular, this can be an externally toothed gearwheel.

The edge or edges which can undergo chamfer machining by means of the device according to the disclosure are optionally the edges of the toothing of the gearwheel with an upper and/or lower end face of the toothed region.

The present disclosure furthermore includes a method for producing a toothed workpiece using a device as has been described above, comprising the steps of:
machining a workpiece held in the workpiece holder using a tool held in the tool holder, and
chamfering at least one edge of the toothed workpiece using an end milling cutter held in the milling cutter holder.

According to a possible embodiment of the present disclosure, it is provided that the pivot arm is located in a parked position during machining of the workpiece using the tool and is moved into a machining position via the second pivot axis in order to chamfer the edge.

According to a possible embodiment of the present disclosure, it is provided that during the chamfer machining a drive of the second pivot axis is actuated synchronously with the rotation of the workpiece, in order to guide the end milling cutter along the edge.

According to a possible embodiment of the present disclosure, it is provided that a breakage control of the end milling cutter takes place by means of a sensor while the pivot arm is in a parked position. In particular, the sensor can be an optical sensor, for example a light barrier, which checks the presence of the tip of the end milling cutter.

According to a possible embodiment of the present disclosure, it is provided that a measurement of the toothing takes place by means of the threading sensor while the pivot arm is in a measuring position.

### BRIEF DESCRIPTION OF THE FIGURES

The present disclosure will now be described in greater detail on the basis of embodiments and drawings, in which:

FIG. 1: is a side view of an embodiment of a chamfering device according to the disclosure, in a first machining position for chamfer machining of a lower edge of a toothing,

FIG. 2: shows the embodiment shown in FIG. 1 in a second machining position for chamfer machining an upper edge of a toothing,

FIG. 3: shows the embodiment shown in FIGS. 1 and 2 in a parked position in which a tool breakage control is performed,

FIG. 4: is a perspective overall view and an enlarged detail view of the chamfering device according to the disclosure in the second machining position,

FIG. 5: is a perspective overall view and an enlarged detail view of the chamfering device according to the disclosure in the parked position,

FIG. 6: is a detailed view of the workpiece breakage sensor and the end milling cutter arranged thereon, from FIG. 5,

FIG. 7: shows the second machining position shown in FIG. 2 for chamfer machining an upper edge of a toothing, in an enlarged detail view of the pivot arm, in which the threading sensor arranged on the pivot arm is visible, and

FIG. 8: shows the embodiment in a measuring position for detecting the tooth gaps by means of the threading sensor.

### DETAILED DESCRIPTION

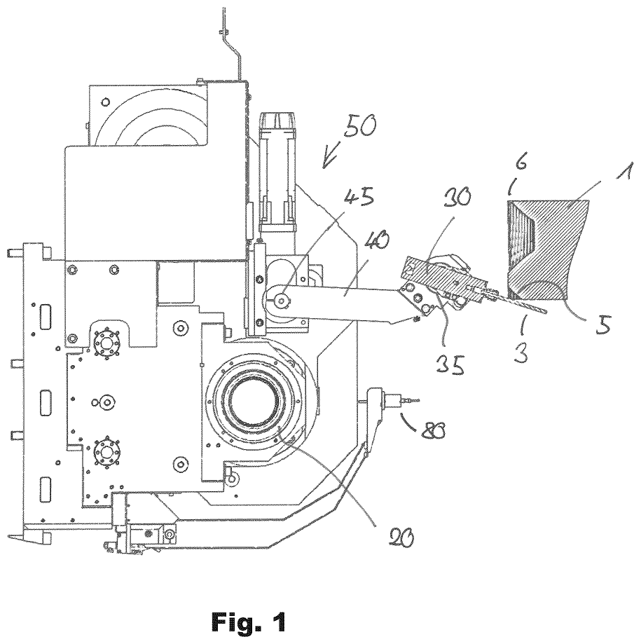

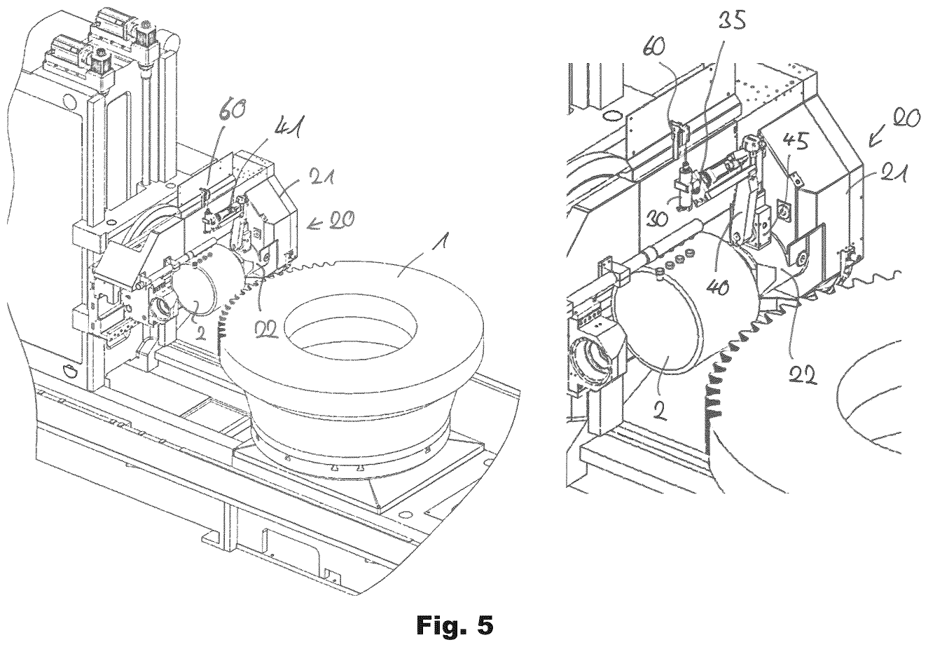

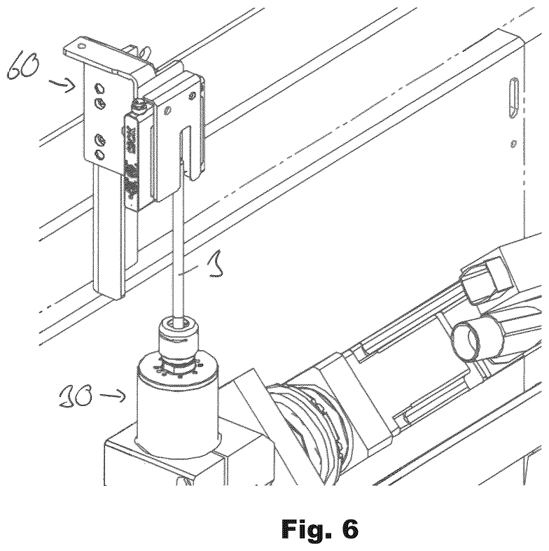

FIGS. 1-8 show an embodiment of a device according to the disclosure for chamfer machining of a toothed workpiece 1.

The device comprises a workpiece spindle 10 having a rotatably mounted workpiece holder for holding the workpiece 1. The workpiece 1 can therefore be rotated via the workpiece spindle about the axis of rotation C1. In this case, in the embodiment, the workpiece spindle comprises an NC drive.

Furthermore, a machining head 50 is provided, on which a tool spindle 20 is provided, on which a tool 2 can be held. In this case, the tool 2 is rotatable about an axis of rotation B1 by means of the tool spindle 20. The tool spindle also has an NC drive.

The machining head comprising the tool spindle 20 is movable relative to the workpiece spindle 10 via at least one, and in the embodiment via a plurality of, linear axes.

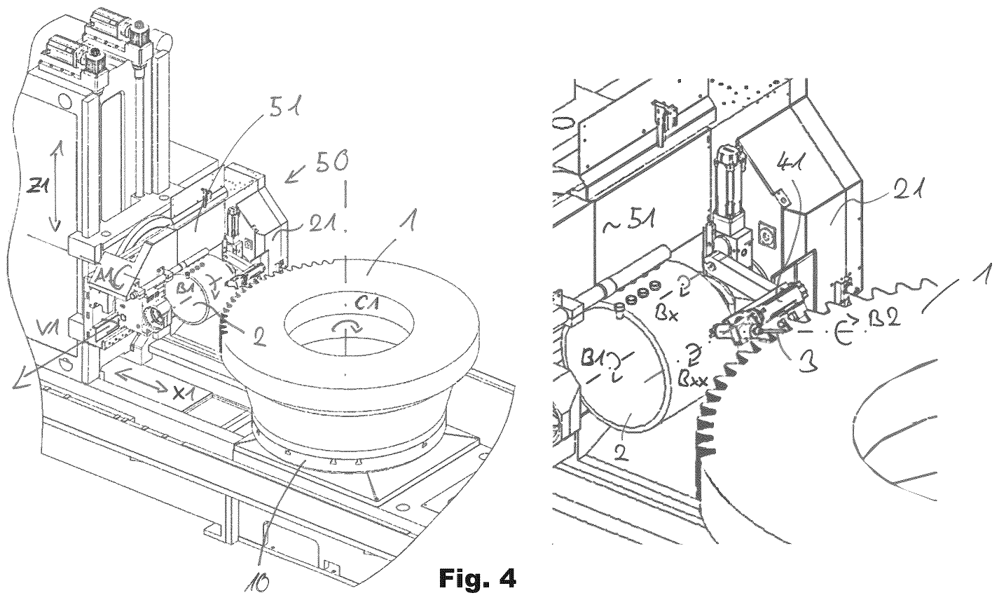

The movement axes with which the machining head 50 is movable in the embodiment are shown in FIG. 4.

In the embodiment, a first linear axis X1 is provided, via which the axial spacing between the tool 2 and the workpiece 1 can be set. In this case, the first linear axis X1 extends perpendicularly to the axes of rotation C1 and B1 of the workpiece spindle and the tool spindle.

Furthermore, a second linear axis Z1 is provided, via which the machining head 50 is movable in parallel with the axis of rotation C1 of the workpiece spindle 10. The tool can be moved by this along the width of the toothing.

Furthermore, the machining head 50 is pivotable via a pivot axis A1, which extends in parallel with the X1-axis, in order to set the axis intersection angle between the axes of rotation C1 and B1 of the workpiece spindle 10 and tool spindle 20.

The axis of rotation B1 of the tool spindle 20 can therefore be rotated via the A1-axis in a plane which extends in parallel with the axis of rotation C1 of the workpiece spindle 10.

Furthermore, a shift axis V1 is provided, via which the tool spindle can be moved in parallel with the axis of rotation B1 of the workpiece spindle. As a result, the axial region of the tool 2 which comes into engagement with the workpiece can be set.

In the configuration shown in the embodiment, the shift axis V1 can be rotated by means of the A1-axis and is provided as a carriage on the machining head 50. In an alternative embodiment, however, the A1-axis could also be arranged on a Y1-axis which is positioned perpendicularly on the X1-axis and on the Z1-axis.

However, the configurations of the device shown in the figures, and in particular the arrangement shown there of the axes, is merely an example. The present disclosure can also be used in toothing machines or other devices for chamfer machining which have a different axial configuration.

The device can in particular be a toothing machine which performs toothing machining of the workpiece 2, by means of the tool 2, for producing or machining the toothing. In this case, the toothing machine optionally comprises a controller having a toothing machining function, via which the axes of the machining head can be actuated in order to perform the toothing machining, for example a gear hobbing process.

However, such an embodiment is not essential within the context of the present disclosure. Rather, the tool holder on the machining head can also, as is known for example from DE 10 2018 108 622 A1, serve for holding a further chamfering tool, for example in order to machine different edges of a workpiece using different chamfering tools.

Irrespective of the intended purpose of the tool, according to the disclosure a milling spindle 30 is additionally provided on the machining head, which carries the tool spindle 20 for holding the tool 2, in which milling spindle an end milling cutter 3 can be held, by means of which the edges 5 and 6 of the workpiece 1 held in the workpiece holder can undergo chamfer machining. The end milling cutter 3 can be set into rotation about the axis of rotation B2 by means of the milling spindle 30. In particular, the end milling cutter is therefore used for chamfering the edges of the toothing which was produced or machined by the tool 2 and is held in the tool holder.

The milling spindle 30 is arranged on the machining head 50 via a pivot arm 40. In this case, the milling spindle 30 is pivotably fastened to the pivot arm 40 via a first pivot axis 35, in particular at the free end of the pivot arm. The pivot arm 40 is in turn pivotably arranged on the machining head via a second pivot axis 45. The first and the second pivot axes 35 and 45 extend in parallel.

The two axes Bx and Bxx of the second and first pivot axis extend in parallel with the axis of rotation B1 of the tool spindle. The axis of rotation of the milling spindle is positioned perpendicularly on the second pivot axis Bxx.

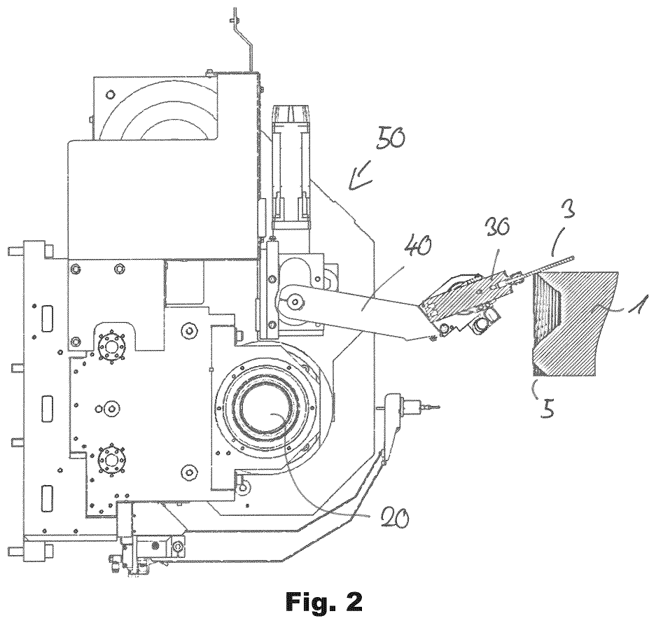

The first pivot axis 35 is, as can be seen in FIGS. 1 and 2, used in the chamfer machining of a lower and upper edge in order to set the work angle of the chamfering milling cutter relative to the edge and thus the angle of the chamfer.

In the machining positions shown in FIGS. 1 and 2, the milling spindle is in each case located in a position beside the workpiece 1, i.e. outside the radial periphery of the workpiece between the upper and the lower end edge of the workpiece. Proceeding from the milling cutter holder, the end milling cutter therefore extends from a radially outer position obliquely to the edge which is chamfered. In particular, in this case the end milling cutter extends, as shown in FIG. 1, for chamfering the lower edge of the workpiece, from outside to inside and from top to bottom to the edge, and for chamfering the upper edge, as shown in FIG. 2, from outside to inside and from bottom to top to the upper edge. During chamfering, the free end of the end milling cutter is located above or below the end face of the workpiece, in a region within the radial position of the edge.

As is also visible from FIGS. 1 and 2, in this case the first pivot axis 35 also serves for pivoting from a first machining position, shown in FIG. 1, for chamfer machining a first edge, into a second machining position, shown in FIG. 2, for chamfer machining a second edge. Furthermore, the first pivot axis 35 is also used for threading the end milling cutter into a tooth gap.

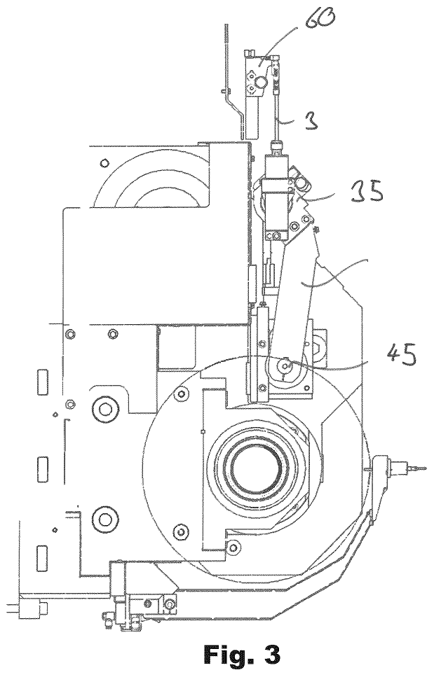

The pivot arm 40 serves, as can be seen from a comparison of FIGS. 1 and 2 with FIG. 3, for pivoting the milling spindle from the parked position shown in FIG. 3 into the machining positions shown in FIGS. 1 and 2.

In the parked position shown in FIG. 3, in this case the end milling cutter 3 and the pivot arm are located outside a collision region of the workpiece 1, during machining of the workpiece, with the tool 2 held in the tool holder 20.

As shown in FIGS. 2, 3 and 6, in the embodiment the end milling cutter 3 held in the milling spindle is located, in the parked position, in the measuring region of the tool breakage sensor 60, such that the controller can detect a tool breakage of the end milling cutter 3 in the parked position. The tool breakage sensor 60 can be configured as an optical sensor. It is in particular a light barrier, in the measuring region of which the tip of the end milling cutter 3 is pivoted when the parked position is approached, and the light path of which is therefore interrupted if the end milling cutter is intact. Therefore, if, in the parked position, the controller does not identify any interruption of the light path of the light barrier, it concludes a tool break and interrupts the chamfering process and/or outputs a warning signal.

In an alternative embodiment, the tool breakage sensor 60 can also be omitted. In this case, the parked position serves only to move the end milling cutter and the pivot arm out of the collision region with the workpiece 1.

The pivot arm 40 enables the milling spindle 30 to be moved in any case from the parked position into an engagement position with the workpiece 1, in which position the end milling cutter 3 performs chamfer machining of an edge of the workpiece.

Furthermore, in the embodiment, the pivot arm 40 is used to move the milling spindle 30, during the chamfer machining, in such a way that the end milling cutter 3 held in said spindle follows the edge of the toothing of the workpiece 1. In particular, therefore, an NC drive is used as the drive for the second pivot axis 45, wherein the drive of the second pivot axis is actuated by the controller of the device synchronously with the rotational movement of an NC drive of the workpiece spindle 10, in order to follow the contour of the edge of the toothing.

During the chamfer machining the second pivot axis 45 substantially assumes a function which could also fall to the Z1-axis, i.e. a movement of the milling spindle in a direction in parallel with the axis of rotation C1 of the workpiece spindle. However, as a result, due to the significantly lower mass of the pivot arm and of the milling spindle 30 compared with the overall machining head, which would have to be moved via the Z1-axis, a significantly quicker and more exact actuation and thus machining can take place.

Although the pivot movement of the pivot arm also leads to a certain movement of the milling spindle 30 in the X1-direction, i.e. radially to the axis of rotation C1 of the workpiece 1, this only slightly shifts the region of the end milling cutter 3 which is in engagement with the edge of the workpiece, and therefore has no influence on the machining result.

Furthermore, the pivot movement of the pivot arm 40 does indeed also lead to some pivoting of the orientation of the axis of rotation B2 of the milling spindle 30 and thus of the end milling cutter, and therefore influences, to a certain extent, the orientation of the chamfer on the workpiece produced by the end milling cutter, but the relatively long extension of the pivot arm 40 compared with the lifting movement of the milling spindle 30 produced by the pivot movement means that the influence on the chamfer angle is relatively small and can, in most applications, be accepted within the permissible tolerances. In this case, the first pivot axis can be actuated as an adjusting axis.

Alternatively, the first pivot axis 35 is also actuated synchronously to the rotation of the workpiece, during the machining process. For this purpose, the first pivot axis 35 optionally has an NC drive.

According to a possible embodiment, the first pivot axis 35 is actuated in the opposite direction to the second pivot axis 45, during the machining process, in order to keep the orientation of the axis of rotation B2 of the milling spindle 30 relative to the axis of rotation C1 of the workpiece constant during the machining process, or to set it to a desired value.

Furthermore, the first pivot axis 35 can be purposely used, during the machining process, to purposely set the work angle for different regions of a tooth gap in each case. In particular, the pivot position of the first pivot axis 35 can therefore also be actuated in a manner synchronized with the rotational movement of the axis of rotation of the workpiece spindle, in order to set different work angles in each case for different regions of a tooth gap.

In addition or alternatively to using the second pivot axis 45 for guiding the end milling cutter along the edge during the machining process, the X1-axis or Z1-axis can optionally also be used in order to perform the chamfer machining.

The linear axes X1, Z1 and V1 are in addition used as adjustment axes for chamfering operation, in order to bring the milling spindle into a suitable starting position for the chamfer machining. In a possible mode of operation, they are no longer adjusted during the chamfer machining.

In a possible embodiment of the present disclosure, the V1-axis is used to position the end milling cutter eccentrically with respect to the workpiece, i.e. the axis of the end milling cutter 3 in any case does not extend, during the chamfer machining, over the entire tooth gap in a radial plane of the workpiece, but rather offset with respect thereto.

In this case, in a first embodiment, the V1-axis is merely used for approaching a starting position for the chamfer machining, in which position the end milling cutter is positioned eccentrically with respect to the workpiece, and is not moved during the chamfer machining. The end milling cutter therefore remains in a fixed position with respect to the central axis of the workpiece during the chamfer machining.

In an embodiment, the V1-axis is, in contrast, actuated, during the chamfer machining, in a manner synchronized with the rotational movement of the axis of rotation of the workpiece spindle, in order to set different V1-positions in each case, for machining, for different regions of a tooth gap. This allows for purposeful influencing of the shape of the chamfer via the tooth gap.

The chamfer machining and thus the actuation of the axes optionally takes place identically for each tooth gap.

In the embodiment shown, the tool spindle 20 is arranged on the machining head in such a way that a boundary wall 51 extends behind the tool 2 held in the tool holder. In this case, the pivot arm 40 is arranged on the machining head, via the pivot axis 45, in such a way that it is located in front of said boundary wall 51. As a result, the length of the pivot arm 40 can be kept relatively short, and nonetheless a deflection can be achieved, via which the workpiece is reached without problem.

In the embodiment, the pivot plane of the pivot arm extends beside a region in which the tool 2 is arranged, and such that the pivot arm cannot collide with the tool.

In the embodiment, for this purpose the second pivot axis 45 is arranged on a main bearing region 22 of the tool spindle 20 and is located beside the housing 21 for the drive of the tool spindle 2.

A strut 41 extending in parallel with the axial direction B1 of the tool spindle is arranged at the free end of the pivot arm 40, which strut carries the first pivot axis 35 and the milling head 30. As a result, the milling head is arranged in an axial position beside the tool 2.

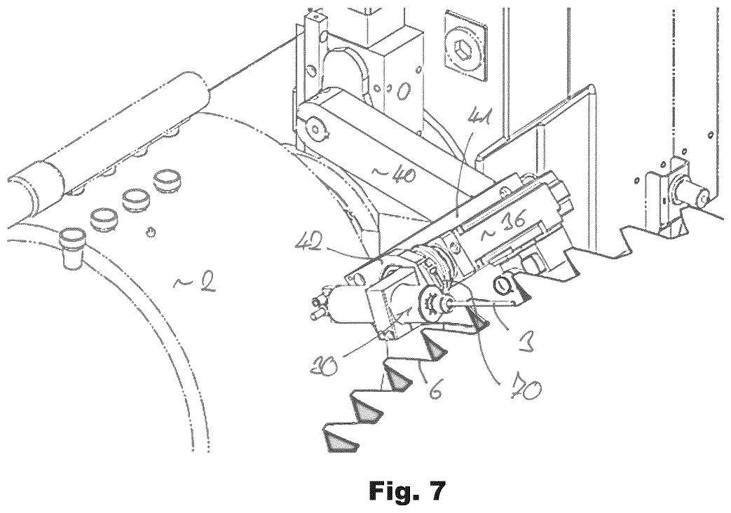

As can be seen in FIG. 7, in this case the strut 41 is arranged rigidly on the pivot arm 40 and carries a mounting element 42 at its free end, on which mounting element the second pivot axis 35 is mounted. The drive 36 for the second pivot axis extends in parallel with the strut 41 from the radially extending part of the pivot arm in the direction towards the free end of the strut.

In the parked position shown in FIGS. 3, 5 and 6, both the pivot arm 40 and the axis of the milling spindle 30 extend upwards along the boundary wall 51. In this case, the tool breakage sensor 60 is arranged on the boundary wall 51, in particular at the upper end of the boundary wall, in such a way that, in the parked position, the end milling cutter 3 held in the milling spindle is located in the measuring region of the tool breakage sensor 60, such that said sensor can detect a tool breakage in the parked position.

Therefore, for moving out of one of the machining positions into the parked position, or for moving out of the parked position into one of the machining positions, typically both pivot axes 35 and 45 are actuated.

Furthermore, a touch sensor 80 is provided on the machining head, which sensor can be moved into position via the machine axes X1, Z1 and V1. However, a detection of the tooth gaps of the workpiece 1 via a touch sensor 80 of this kind is complex, since said sensor must first be laboriously moved into a measuring position in front of the toothing. Furthermore, a touch sensor of this kind must be moved slowly in the vicinity of the toothing, in order to prevent damage.

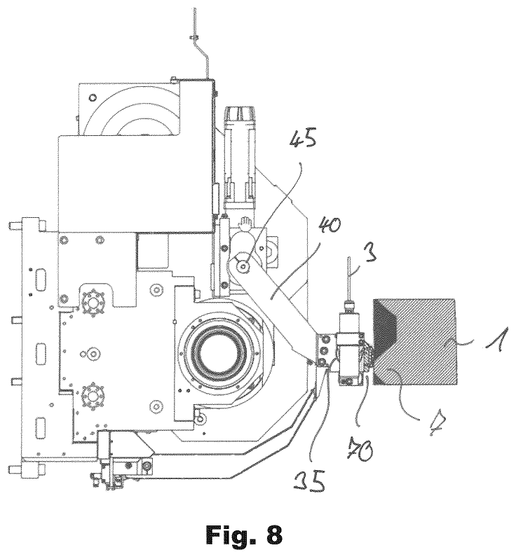

Therefore, alternatively or additionally, according to a second aspect of the present disclosure a threading sensor 70 is provided on the pivot arm 40 (see FIGS. 7 and 8).

In the embodiment, the threading sensor 70 is arranged on the free end of the pivot arm with respect to the first pivot axis, viewed in the radial direction, and specifically on the strut 41 extending in parallel with the axial direction B1 of the tool spindle, which strut extends the pivot arm as far as in front of the region of the tool 2.

In this case, the threading sensor 70 is arranged in the region of the end of the strut 41 facing away from the pivot arm, and thus directly beside the milling spindle 30, in the exemplary embodiment on the mounting element 42 for the second pivot axis 35. As a result, the spacing between the threading sensor and the milling spindle can be kept particularly small.

The threading sensor 70 operates in a contactless manner, and can for example inductively, capacitively or optically detect the teeth 7 or tooth gaps of the toothing when it is located in the measuring position shown in FIG. 8.

In this case, with respect to the pivot position of the first pivot axis 45 the measuring position substantially corresponds to the machining positions. In particular, the first pivot axis is set in the machining positions and/or the measuring position such that the second pivot axis 35 is located beside the workpiece to be machined, between the upper and lower edge of the toothing.

As a result, the threading sensor in the measuring position is also located beside the toothing and can detect the teeth or tooth gaps.

The second pivot axis 35 is set, in the measuring position, in such a way that the end milling cutter 3 held in the milling spindle 30 is out of engagement with the toothing and the milling spindle itself also does not form any interfering contour. In this case, in particular the axis of rotation of the milling spindle can extend in parallel with the axis of rotation of the workpiece spindle.

After the detection of the tooth gaps of the toothing, the second pivot axis 35 is used in order to pivot the end milling cutter into a chamfer machining position, as shown in FIG. 7. In this case, the linear axes of the machining head merely have to be moved with small travel paths for moving from the measuring position into the chamfer machining position, since the milling spindle is already located in the direct vicinity of the workpiece.

It is also possible to change very quickly from machining operation, in which the workpiece 1 is machined using the tool 2 held in the tool holder, in particular undergoes toothing machining for producing the toothing, into the measuring position and/or chamfer machining position.

For this purpose, only the machining head has to be moved back via the X1-axis, in order to bring the tool 2 out of engagement with the workpiece and to provide sufficient space between the tool 2 and workpiece 1 for the milling spindle.

Thereupon, the milling spindle can be moved out of the parked position into the region between the tool 2 and workpiece 1, by pivoting the pivot arm 40 by means of the first pivot axis 45, such that at the same time the threading sensor 70 is also located in a region in front of the toothing of the workpiece.

In this case, firstly the measuring position shown in FIG. 8 and, after detection of the teeth or tooth gaps, one of the chamfer machining positions, can be approached.

1. Device for chamfer machining of a toothed workpiece, wherein the device comprises
at least one workpiece spindle having a rotatably mounted workpiece holder for holding the workpiece, and
a machining head that is movable relative to the workpiece spindle via at least one linear axis, wherein at least one tool spindle having a rotatably mounted tool holder for holding at least one tool for machining a workpiece held in the workpiece holder is provided on the machining head,
and wherein a milling spindle having a rotatably mounted milling cutter holder for holding an end milling cutter for chamfer machining an edge of a toothing of the workpiece held in the workpiece holder is provided on the machining head,
wherein the work angle of an end milling cutter held in the milling cutter holder relative to the edge of the toothing can be set via a first pivot axis,
wherein
the milling spindle is pivotably arranged on a pivot arm via the first pivot axis, wherein the pivot arm in turn is pivotably arranged on the machining head via a second pivot axis which is oriented in parallel with the first pivot axis.

2. Device according to claim 1, further comprising a first drive for the first pivot axis and a second drive for the second pivot axis and a controller for actuating the first and the second drive, wherein the controller is configured and/or programmed to actuate the first drive in a machining position for setting the work angle of an end milling cutter held in the milling cutter holder relative to the edge of the toothing, and/or for switching between machining of an upper edge and a lower edge of the toothing, and/or wherein the controller is configured and/or programmed to position the milling spindle in a machining position in which an end milling cutter held in the milling cutter holder extends proceeding from a position beside the workpiece with an oblique orientation to the edge of the toothing.

3. Device according to claim 1, further comprising a first drive for the first pivot axis and a second drive for the second pivot axis and a controller for actuating the first and the second drive, wherein the controller is configured and/or programmed to move the pivot arm with the milling spindle from a machining position into a parked position and/or back.

4. Device according to claim 1, further comprising a controller for actuating an NC drive of the second pivot axis, wherein the controller comprises a chamfer machining function which is configured and/or programmed to actuate the second pivot axis, during chamfer machining, synchronously to a rotation of the workpiece spindle, in order to guide an end milling cutter, held in the milling cutter holder, in a controlled manner along the edge of a toothed workpiece held in the workpiece holder.

5. Device according to claim 4, wherein the chamfer machining function is configured and/or programmed to actuate the first pivot axis synchronously to a rotation of the workpiece spindle during chamfer machining, and/or
wherein the machining head is movable via at least one linear axis in parallel with the axis of rotation of the tool holder and/or in parallel with the first and/or second pivot axis, wherein the chamfer machining function is configured and/or programmed to actuate the linear axis synchronously with a rotation of the workpiece spindle.

6. Device for chamfer machining of a toothed workpiece, wherein the device comprises
at least one workpiece spindle having a rotatably mounted workpiece holder for holding the workpiece, and
a machining head that is movable relative to the workpiece spindle via at least one linear axis, wherein at least one tool spindle having a rotatably mounted tool holder for holding at least one tool for machining a workpiece held in the workpiece holder is provided on the machining head,
and wherein a milling spindle having a rotatably mounted milling cutter holder for holding an end milling cutter for chamfer machining an edge of a toothing of the workpiece held in the workpiece holder is provided on the machining head,
wherein the milling spindle is arranged on the machining head via a pivot arm,
wherein
a threading sensor is arranged on the pivot arm.

7. Device according to claim 6, wherein the threading sensor is arranged on the free end of the pivot arm, and/or
wherein the pivot arm is pivotably arranged on the machining head via a first pivot axis and the device comprises a controller which is configured and/or programmed to move the pivot arm into a measuring position in which the threading sensor is located in front of the toothing to be measured.

8. Device according to claim 1, wherein a work region for the tool on the machining head is limited to the rear by a boundary wall provided behind the tool, wherein the second pivot axis is arranged on the machining head in a region in front of the boundary wall.

9. Device according to claim 1, wherein the pivot arm is arranged axially beside the tool holder with respect to the direction of the axis of rotation of the tool spindle and therefore pivots in a region beside a tool held in the tool holder, and/or wherein the second pivot axis is arranged on a housing of the main bearing of the tool spindle.

10. Device according to claim 1, comprising a sensor for breakage control of an end milling cutter held in the milling cutter holder.

11. Device according to claim 1, wherein the tool spindle is a tool spindle for toothed machining of a workpiece held in the workpiece holder, and/or wherein the device is a toothed machine.

12. Device according to claim 1, wherein the machining head is movable via at least two linear axes.

13. Method for producing a toothed workpiece using a device according to claim 1, comprising the steps of:
machining a workpiece held in the workpiece holder using a tool held in the tool holder, and
chamfering at least one edge of the toothed workpiece using an end milling cutter held in the milling cutter holder.

14. Method according to claim 13, wherein the pivot arm is located in a parked position during machining of the workpiece using the tool, and is moved into a machining position via the second pivot axis in order to chamfer the edge, and/or wherein during the chamfer machining a drive of the second pivot axis is actuated synchronously with the rotation of the workpiece, in order to guide the end milling cutter along the edge.

15. Method according to claim 13, wherein a breakage control of the end milling cutter takes place by means of a sensor, while the pivot arm is in a parked position, and/or wherein a measurement of the toothing takes place by the threading sensor while the pivot arm is in a measuring position.

16. Device according to claim 3, wherein the first and the second pivot axis are moved into the machining position upon movement, such that an angle between the axis of rotation of the milling spindle and a main extension direction of the pivot arm changes.

17. Device according to claim 10, wherein the sensor is arranged such that it checks the end milling cutter in a parked position of the pivot arm.

18. Device according to claim 12, wherein a first linear axis is provided for movement in a direction perpendicular to the axis of rotation of the workpiece holder and perpendicular to the axis of rotation of the tool holder, and a second linear axis is provided for movement in a direction in parallel with the axis of rotation of the workpiece holder.

19. Device according to claim 12, wherein the machining head is pivotable via a pivot axis relative to the workpiece spindle for setting an axis intersection angle, and wherein the pivot axis extends perpendicularly to the axis of rotation of the workpiece holder and perpendicularly to the axis of rotation of the tool holder.

20. Device according to claim 7, wherein the milling spindle is arranged on the pivot arm via a second pivot axis and the controller actuates the second pivot axis in such a way that an end milling cutter held in the milling spindle is out of engagement with the toothing in the measuring position, and/or the threading sensor is a sensor that operates in a contactless manner.
